(19) United States
(12) Patent Application Publication
(10) Pub. No.: US 2011/0221766 A1
(43) Pub. Date: Sep. 15, 2011

(54) METHOD FOR PRINTING A CAPTURED SCREEN OF WEB PAGES

(75) Inventors: Jun Yong KO, Gyeonggi-Do (KR); Nak Cheol Sung, Seoul (KR)

(73) Assignee: DESIGNMADE Co., LTD., Seoul (KR)

(21) Appl. No.: 12/720,181

(22) Filed: Mar. 9, 2010

(51) Int. Cl. G09G 5/00; G06F 3/048; G06F 17/00

(52) U.S. Cl. 345/629; 715/785; 715/234

(57) ABSTRACT

Provided is a method for printing a captured screen of a web page. If the total size of a web page displayed on a web browser screen is greater than the monitor resolution of a web user, the method automatically scrolls the web browser screen in the horizontal/vertical direction to capture the total region of the web page into a plurality of segments and combines the captured web page screen segments to print or store the same as one web page screen. The method can overcome a problem that the quality of a printed material degrades when a captured screen of a web page displayed on a web browser screen is converted in a bitmap format prior to printing, a problem that a web page viewed by a web user through a web browser screen is not identically printed due to the restricted maximum size of a bitmap if the web page is long, and a problem that the web page contents exceeding the monitor screen of a web user are not printed if the total size of a web page is greater than the monitor resolution of the web user when a captured screen is converted into an Enhanced Meta File (EMF) prior to printing in order to improve the quality of a printed material.

### BACKGROUND OF THE INVENTION

1. Field of the Invention

The present invention relates to a web page printing method, and more particularly, to a method for printing a captured screen of a web page, which scrolls a web browser screen to capture the total region of a web page into a plurality of segments and combines the captured web page screen segments to print or store the same as one web page screen.

2. Description of the Related Art

When a web user accesses a certain web server by means of a web browser and loads a web page on the web browser, the wed browser displays the web page in a specific screen size according to the monitor resolution of the web user. In general, only a portion of the total wed page is displayed on the screen and a user interface such as a scroll bar is provided to enable the user to view the other portions of the web page.

For example, when the monitor resolution of the web user is set to 600×400 and a web page with a total size of 1000×1300 is loaded on the web browser as illustrated in FIG. 1, the web browser displays only a portion of the total web page in the size of 600×400 as illustrated in FIG. 2 and the web user may use a horizontal/vertical scroll bar to view the other portions of the total web page.

In this manner, when the web browser displays only a portion of the total web page, the web user may print the current web page through a print function of the web browser or other print program.

### SUMMARY OF THE INVENTION

However, if a print function of the web browser or other print program is used to print the web page displayed on a web browser screen, a screen captured through a screen capture function is converted into a bitmap format prior to printing, thus degrading the quality of the printed material. Also, because the maximum size of bitmap generation is restricted by the memory capacity of a web user computer system, if the web page is long, there is a high possibility that the web page may be abnormally printed. For example, if the print function of the web browser is used to print a web page as illustrated in FIG. 3, it fails to equally print the web page viewed through the web browser screen by the web user as illustrated in FIG. 4. It can be seen from FIG. 4 that the actual desired contents of the web user in FIG. 3 are not printed at all.

Unlike this, a technique of converting a captured screen into an Enhanced Meta File (EMF) format prior to printing has been proposed as a scheme for improving the quality of the printed material of the web page displayed on the web browser screen. In this case, if the total size of the web page is much larger than the current monitor resolution of the web user, the contents exceeding the monitor screen of the web user are not printed as illustrated in FIG. 5.

For reference, a metafile such as an EMF is a format for storing a raster-type graphic element (e.g., a bitmap) and a vector-type graphic element (e.g., a line, a figure and a letter) together. In this context, the use of a web screen rendering interface of a web browser makes it possible to divide the HTML elements of a web page into a vector-type graphic element and a raster-type graphic element prior to extraction. That is, the bitmap of the web page is stored in a raster format and the letter, line and figure of the web page are stored in a vector format.

An object of the present invention is to provide a method for printing a captured screen of a web page, which, if the total size of a web page displayed on a web browser screen is greater than the monitor resolution of a web user, automatically scrolls the web browser screen in the horizontal/vertical direction to capture the total region of the web page into a plurality of segments and combines the captured web page screen segments to print or store the same as one web page screen.

According to an aspect of the present invention, there is provided a method for printing a captured screen of a web page, including: a first process of loading, by a web user, a capture printing agent for a capture screen print service on a web browser through a web browser loading module included in the capture printing agent; a second process of obtaining, by a web browser control module included in the capture printing agent, the total size of the web page and the size of a web page of the current web browser screen display region to calculate the necessary number of automatic horizontal/vertical scrolls of the web browser screen, in the event of a printing request of the web user in the state where the capture printing agent is loaded on the web browser; a third process of automatically scrolling, by a scroll capturing module included in the capture printing agent, the web browser screen in the horizontal/vertical direction according to the necessary number of the scrolls calculated by the web browser control module and using a metafile Device Context (DC) among the Graphic Device Interface (GDI) subsystem functions of a Windows operating system to capture the total region of the web page into a plurality of metafile segments; a fourth process of removing, by a clipping module included in the capture printing agent, unnecessary graphic elements from the captured metafile segments to generate secondary metafiles including only pure web page contents; and a fifth process of combining, by a capture screen printing module included in the capture printing agent, the secondary metafiles generated by the clipping module to print or store the same as one web page screen.

In order to provide a function for improving the printing quality while printing a web page, viewed through a web browser by a web user, in the same format as a display screen, the inventor has developed a Layered Meta File (LMF) technique for printing/storing captured web page screen segments as one web page screen by combining the captured web page screen segments in a partially layered manner.

The LMF technique according to the present invention is an application type of the conventional Enhanced Meta File (EMF) technique. The LMF technique according to the prevent invention captures/stores/prints a web page, viewed through a web browser by a web user, not in a bitmap format but in a format for storing graphic commands and graphic data together, thus making it possible to store the graphic data of the web page without degrading the printing quality of the web page.

A Windows Operating System (OS) processes a graphic task through a subsystem such as a Graphic Device Interface (GDI). The GDI manages all of the output-related information such as font, color, thickness, pattern and output format by using a data structure such as a Device Context (DC). Examples of the DC include a display DC for screen display, a printer DC for printing, a memory DC used for bitmap output, and a metafile DC for acquisition of graphic information. Among them, the metafile DC may be used to acquire information about a graphic command that an application executes through a GDI for display. The present invention uses the metafile DC and a web browser screen rendering interface of a web browser to capture the contents of a web page that is being displayed by the web browser. Compared to the bitmap-based technique, the technique of the present invention can store more graphic information by much less memory capacity.

In the metafile, the graphic command executed by the application is represented by a unique ID value, and related data and parameters necessary for the graphic command execution are stored in a data structure format. For example, if a lining task in the application is stored in the metafile, a constant value “EMR_LINETO” is used to indicate that the graphic command executed by the application is a lining and a lining position value (Horizontal, Vertical) is stored as a parameter.

The present invention loads an agent-type module on a web browser in order to capture the contents of a web page displayed by the web browser through the LMF technique. As described above, the EMF technique and a web screen rendering interface of the web browser are used to capture a web screen displayed the web browser, wherein the web screen rendering interface provides a function of depicting the current screen of the web browser in the inputted DC. At this point, the present invention captures the current screen of the web browser by inputting a metafile DC among various DCs provided by the Windows OS. However, due to the characteristics of the Windows OS, each process under execution operates in a separate independent address region. Therefore, the present invention uses a web browser extension module such as an ActiveX, a Browser Helper Object (BHO), a toolbar, a toolbar button and a hooking module to load an agent module on an address space such as a web browser. If the agent module is not loaded on the web browser, because the metafile and the web screen rendering interface of the web browser cannot be used due to the characteristics of the Windows OS as described above, the web screen cannot be correctly captured

When the agent module is loaded on the web browser, the agent module acquires information about a Document Object Model (DOM) tree structure for the web page and the web screen rendering interface of the web browser. The web browser accesses a web server to download an HTML file type web page and interprets the HTML file to display the web page, wherein the DOM tree structure is a data structure corresponding to an object type of each tag of the HTML file.

As illustrated in FIG. 2, the web browser displays only a portion of the web page on the web browser screen. However, because the web user wants to print the total contents of the web page, the printing of only the current web browser screen is meaningless. Also, the web screen rendering interface provided by the web browser depicts only the current web screen of the web browser in the DC without outputting the total webpage contents to the DC. Therefore, the use of only the web screen rendering interface of the web browser cannot print the total web page desired by the web user.

Thus, in order to capture a screen of the total web page, the present invention acquires web screen segments while continuing to forcibly scroll a web screen to certain positions by means of the function of a web browser, and combines the web screen segments to acquire the total web page. In order to detect the number of scrolls of the web browser screen necessary for acquiring the screen segments of the total web page, the present invention uses the acquired DOM information to obtain the actual size of the web page loaded by the web browser on a pixel basis. Thereafter, the present invention obtains the current screen size of the web browser and uses the two values to calculate the number of horizontal/vertical scrolls necessary for displaying the total web page on the web browser screen.

Thereafter, a clipping module is used to remove graphic elements irrelevant to the web page (a portion of the web browser screen) for the primary metafile to generate a secondary metafile. Upon completion of the above processes, the web page is captured into a plurality of segments. The segments are stored in a data structure format together with the coordinates on the actual web page obtained through the DOM tree structure. The LMF module combines position information and captured web page screen segments so that they can be stored and printed as one web page. The captured web page screen may be stored in a file for later use.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an embodiment of a web page with a total size of 1000×1300;

FIG. 2 illustrates a web browser screen displaying the web page of FIG. 1 if the resolution of a monitor is set to 600×400;

FIG. 3 illustrates a web browser screen displaying a web page of a certain size;

FIG. 4 illustrates a display screen that print-previews the web page of FIG. 3 through a print function of a web browser;

FIG. 5 illustrates an embodiment of the printed state of a web page if the total size of the web page is greater than the monitor resolution;

FIG. 6 illustrates an embodiment of a capture screen print service agent according to the present invention;

FIG. 7 is a flow chart illustrating a web page capture screen printing method according to the present invention;

FIG. 8 illustrates an embodiment of a process for a web browser to display a HTML-format web page;

FIG. 9 illustrates an embodiment of the number of horizontal/vertical scrolls of a web browser screen;

FIG. 10 illustrates an embodiment where the initial scroll position of the current web browser screen moves to the start point of the web page;

FIG. 11 illustrates an embodiment of a process for automatically scrolling the web browser screen from the start point of the web page in the horizontal/vertical direction to capture the total region of the web page into a plurality of segments;

FIGS. 12 to 19 each illustrates a web browser screen that is displayed by scroll-capturing a portion of the total region of the web page of FIG. 11;

FIG. 20 illustrates an embodiment of a process for dividing the web browser screen of each scroll position into metafile segments by using a web screen rendering interface of the web browser;

FIG. 21 illustrates an embodiment of a metafile corresponding to the captured screen of FIG. 12;

FIG. 22 illustrates an embodiment of a process for removing unnecessary graphic elements from the metafile of FIG. 21 to generate a secondary metafile including only pure web page contents;

FIG. 23 illustrates an embodiment of secondary metafiles corresponding to the captured screens of FIGS. 12 to 19; and

FIG. 24 illustrates an embodiment of a process for combining the secondary metafiles of FIG. 23 to generate one web page screen.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

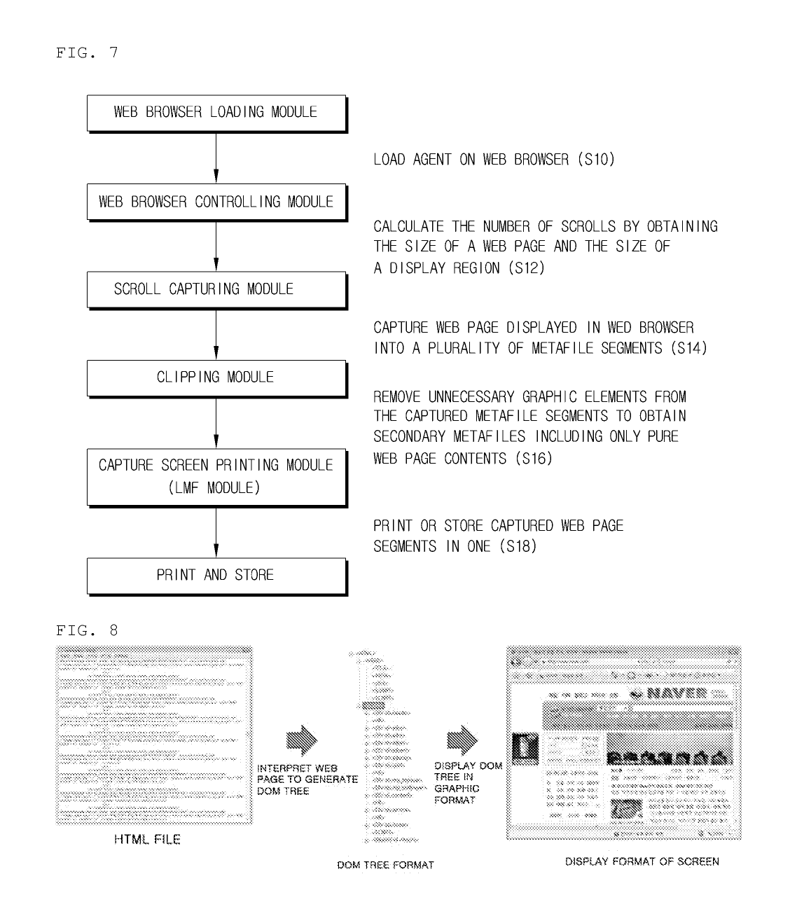

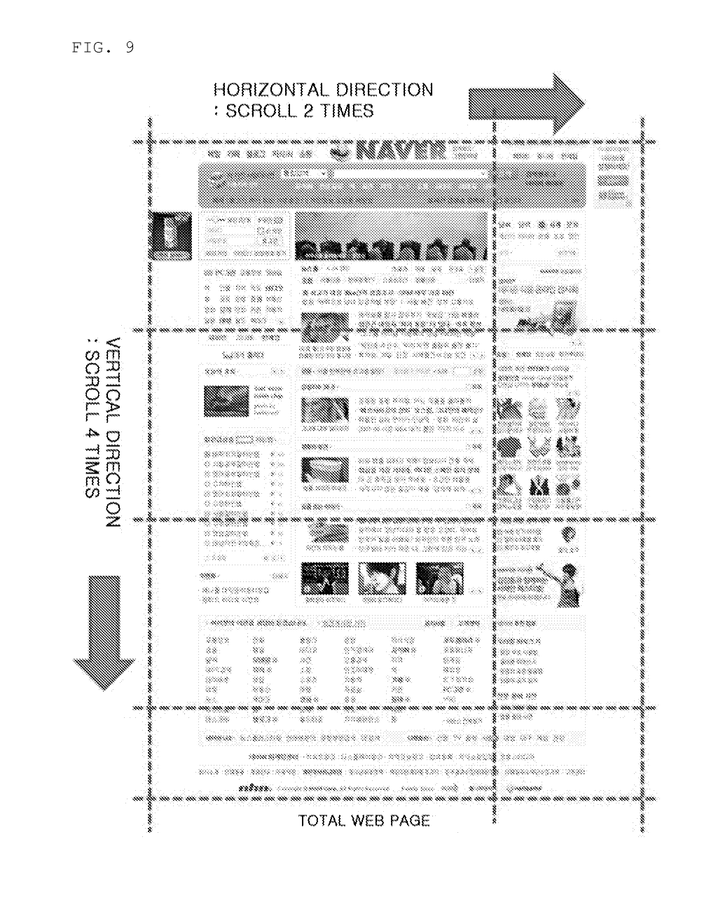

FIG. 6 illustrates an embodiment of an agent 10 for a web page capture screen print service (hereinafter referred to as a capture printing agent) according to the present invention. A method for printing a captured screen of a web page is performed according to an operation of the capture printing agent 10 loaded on a web browser by a web developer or a web user.

The capture printing agent 10 includes a web browser loading module 11, a web browser control module 12, a scroll capturing module 13, a clipping module 14, and a capture screen printing module 15.

The web browser loading module 11 loads the capture printing agent 10 on the web browser, and may be implemented using a web browser extension module such as an ActiveX, a Browser Helper Object (BHO), a toolbar, a toolbar button and a hooking module.

For example, the web developer may use ActiveX technique to load the capture printing agent 10 on a web browser HTML. Also, the web user may use one of the BHO, toolbar, toolbar button of the web browser to load the capture printing agent 10 on the web browser through an installation program.

The web browser control module 12 obtains the total size of the web page and the size of a web page of the current web browser screen display region to calculate the necessary number of automatic horizontal/vertical scrolls of the web browser screen, in the event of a printing request of the web user in the state where the capture printing agent 10 is loaded on the web browser.

The scroll capturing module 13 automatically scrolls the web browser screen in the horizontal/vertical direction according to the necessary number of the scrolls calculated by the web browser control module 12 to capture the total region of the web page into a plurality of metafile segments.

The clipping module 14 removes unnecessary graphic elements from the captured web page screen segments, i.e., the captured metafile segments to generate secondary metafiles including only pure web page contents.

The capture screen printing module 15 combines the secondary metafiles generated by the clipping module 14 to print or store the same as one web page screen.

A metafile such as the secondary metafile stores graphic elements such as lines, figures and letters included in the web page in a vector format. Therefore, if the secondary metafiles are simply combined prior to output, there occurs a gap between the secondary metafile segments in a printing or storing operation. In order to compensate this, the capture screen printing module 15 combines the secondary metafile segments in a partially layered manner, for example, by about 1˜3 pixels.

As described above, the capture screen printing module 15 combines the captured web page screen segments including only pure web page contents, i.e., the secondary metafile segments in a partially layered manner to print or store the same as one web page screen. Thus, the capture screen printing module 15 is referred to as a Layered Meta File (LMF) module.

Hereinafter, a detailed description will be given of a process of printing a captured screen of a web page according to the present invention, which is performed according to an operation of the capture printing agent 10.

When the web user accesses a web server to load a web page to a web browser, the web browser loading module 11 of the capture printing agent 10 loads the capture printing agent 10 on the web browser (S10).

At this point, an ActiveX technique may be used to enable the capture printing agent 10 to be loaded on a web browser HTML when the web user accesses the web page. Unlike this, one of the BHO, toolbar and toolbar button of the web browser may be used to enable the web user to load the capture printing agent 10 on the web browser through an installation program.

The web browser control module 12 obtains the total size of the web page and the size of a web page of the current web browser screen display region to calculate the necessary number of automatic horizontal/vertical scrolls of the web browser screen, in the event of a printing request of the web user in the state where the capture printing agent 10 is loaded on the web browser (S12).

Hereinafter, a detailed description will be given of the process (S12) for calculating the necessary number of scrolls by the web browser control module 12.

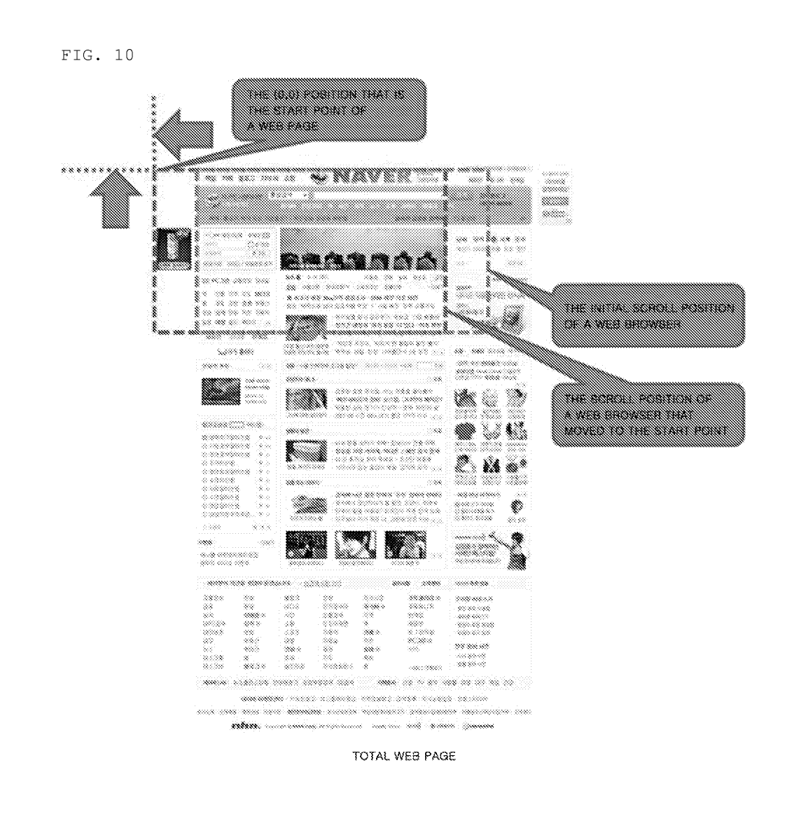

The web browser accesses a web server to download a HTML file type web page, and interprets the HTML file for screen display. At this point, a tag defined in the HTML file is internally managed in one object format. Also, because the objects have a parent/child relationship, the web browser manages the objects in a tree format, which is called a Document Object Model (DOM) tree. In the DOM tree, each object corresponds to one tag in the HTML file, which is called a DOM node. The DOM node provides various information such as the style information of a tag set in a CSS (cascading style sheets) file format in the HTML file, the pixel-based position value of the node represented on the web browser, and the HTML source information and the tag name corresponding to the node. For reference, FIG. 8 illustrates a process of the web browser interpreting an HTML file type web page to generate a DOM tree and displaying the DOM tree in a graphic format viewable by the web user.

The web browser control module 12 obtains a DOM tree from the web browser, obtains a DOM node (HTML tag or BODY on HTML) representing the web page among the nodes of the DOM tree, and obtains the total size of the node and the size of a region displayed on the web browser screen on a pixel basis.

When the total size of the node is obtained, the actual total size of the web page can be obtained on a pixel basis. Also, when the size of a region displayed on the web browser screen is obtained, the size of a region among the web page contents displayed in the web browser can be obtained.

Herein, the obtained value is not the window size of the web browser but the size of a web page display region in the window of the web browser.

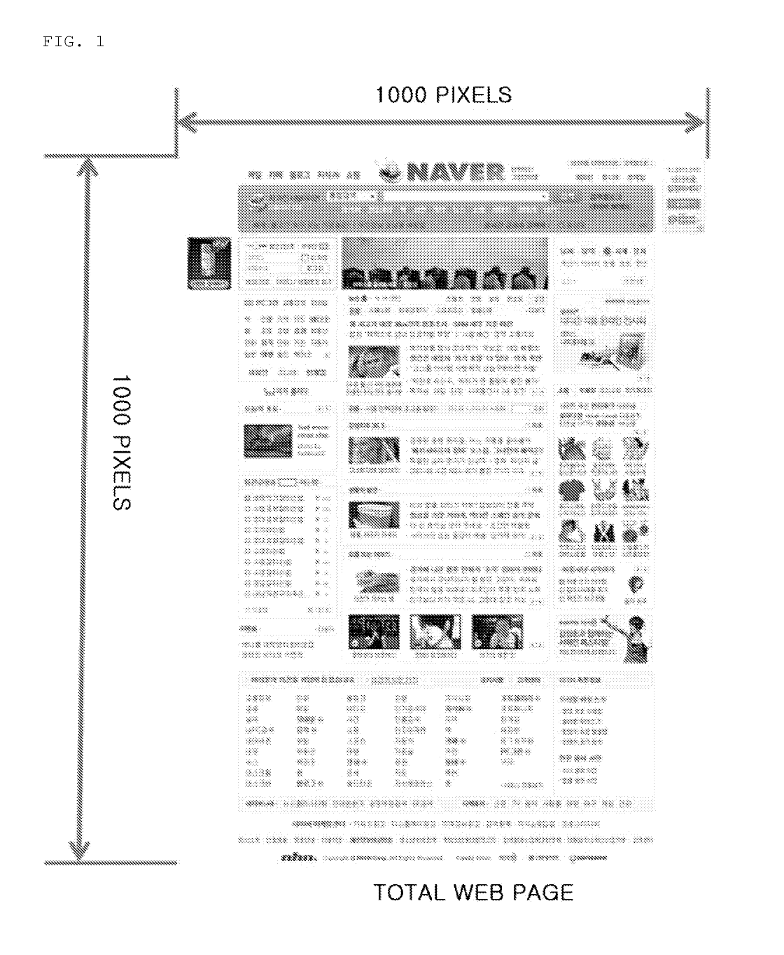

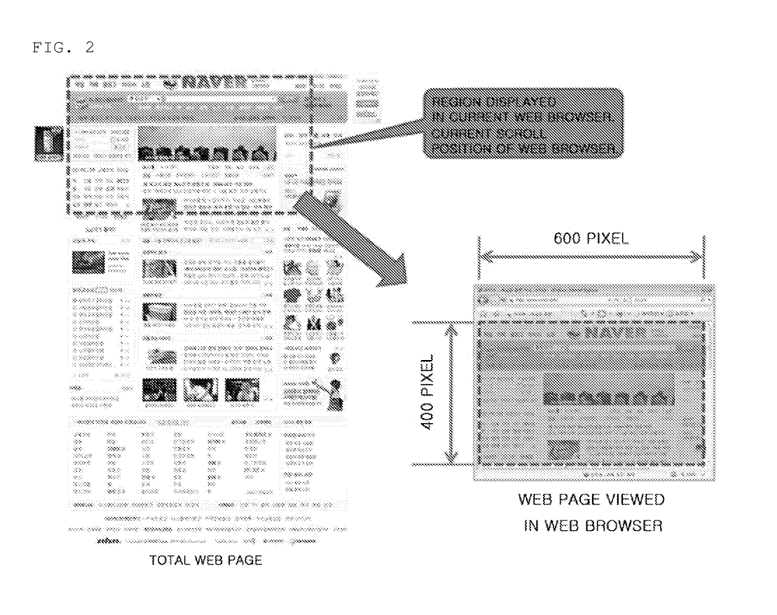

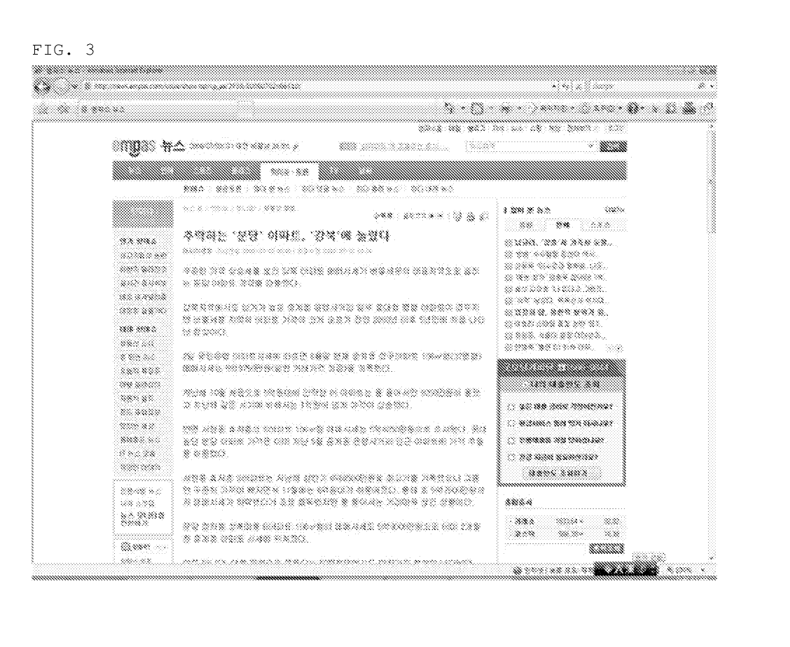

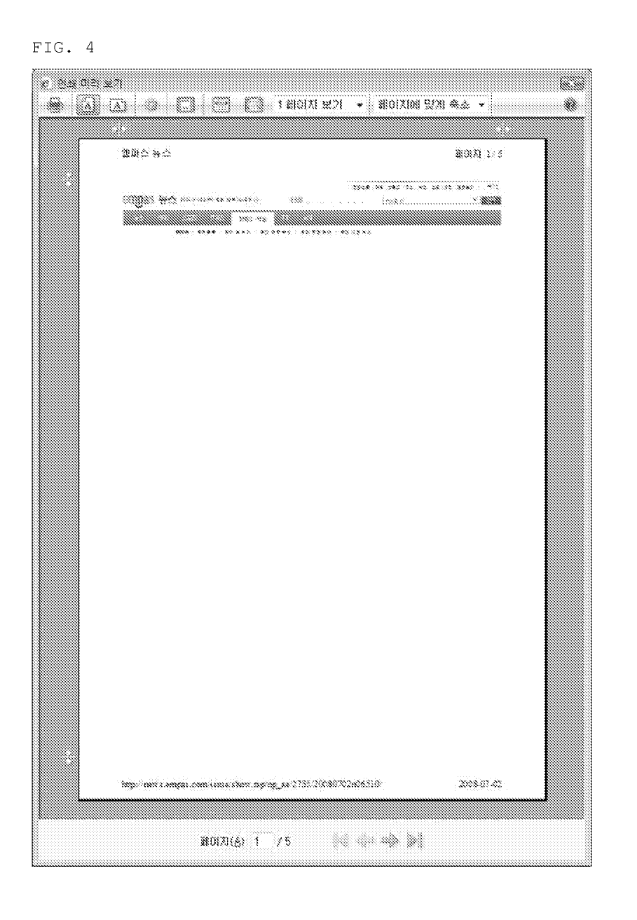

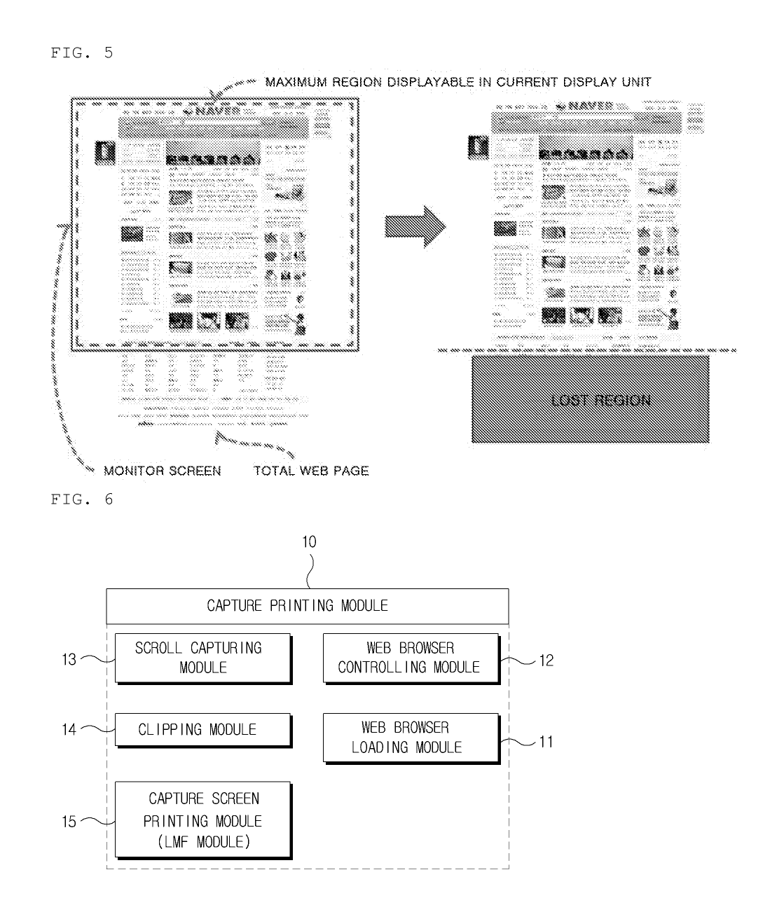

For example, as illustrated in FIG. 2, the web browser displays only a portion of the web page, but the obtained value is the size of a region represented by a dotted line box. FIG. 2 illustrates that a portion of the total web page is displayed in a 600×400 size when the monitor resolution of the web user is set to 600×400 and the web page with a total size of 1000×1300 is loaded to the web browser as illustrated in FIG. 1.

As illustrated in FIG. 2, if a portion of the web page with a total size of 1000×1300 is displayed in the web browser in a 600×400 size, when the web browser control module 12 obtains the total size from a web page DOM node in a DOM tree, the value of horizontal 1000 pixels and vertical 1300 pixels, which is the size of the web page, can be obtained. Also, when the size of a current web page display region is obtained from the web page DOM node, the value of horizontal 600 pixels and vertical 400 pixels can be obtained.

Because the web page displayed on the web browser screen are horizontally 600 pixels, it can be seen that 2 (=1000/600) times of horizontal scroll is necessary to display the total web page. Likewise, the total necessary scroll time is obtained by dividing the size of the total web page by the size of a region displayed on the web browser.

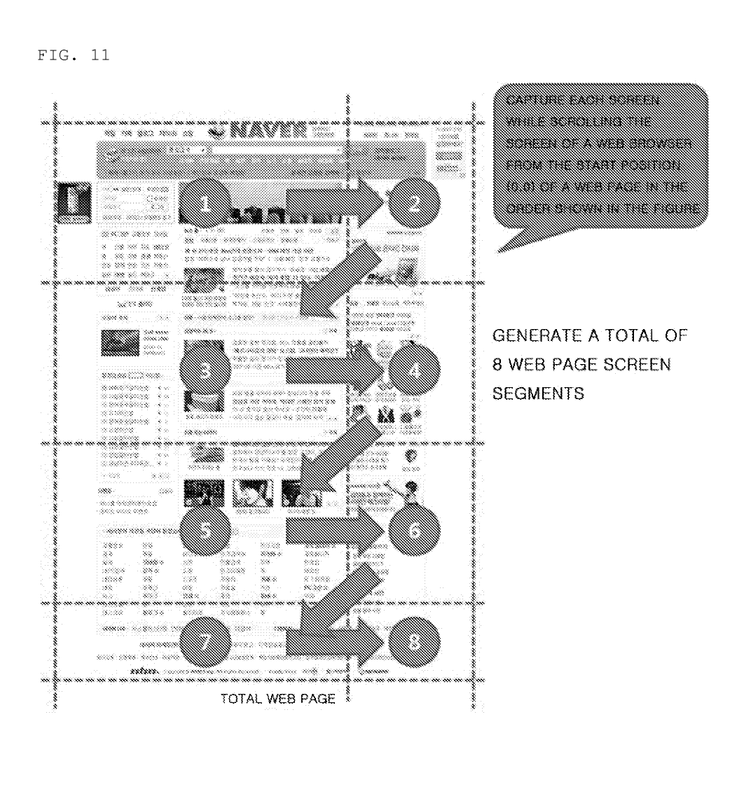

That is, it can be seen that 2 (horizontal=1000/600) times of horizontal scroll is necessary and 4 (vertical=1300/400) times of vertical scroll is necessary. Thus, as illustrated in FIG. 9, it can be seen that 8 times (=horizontal scroll times (2 times)×vertical scroll times (4 times)) of scroll is necessary to display the total web page contents on the web browser.

After the necessary number of automatic horizontal/vertical scrolls of the web browser screen is calculated by the web browser control module 12 (S12), the scroll capturing module 13 automatically scrolls the web browser screen in the horizontal/vertical direction according to the calculated scroll number to capture the total region of the web page into a plurality of segments, i.e., a plurality of metafile segments (S14).

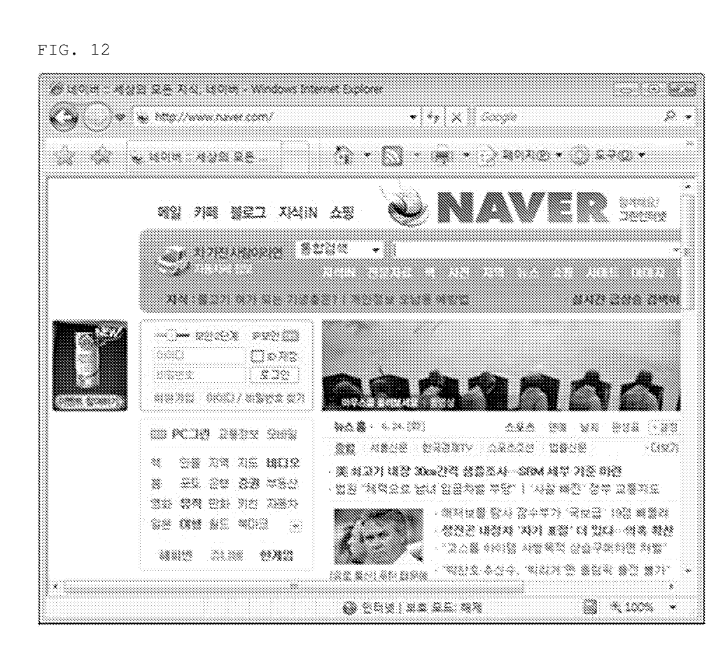

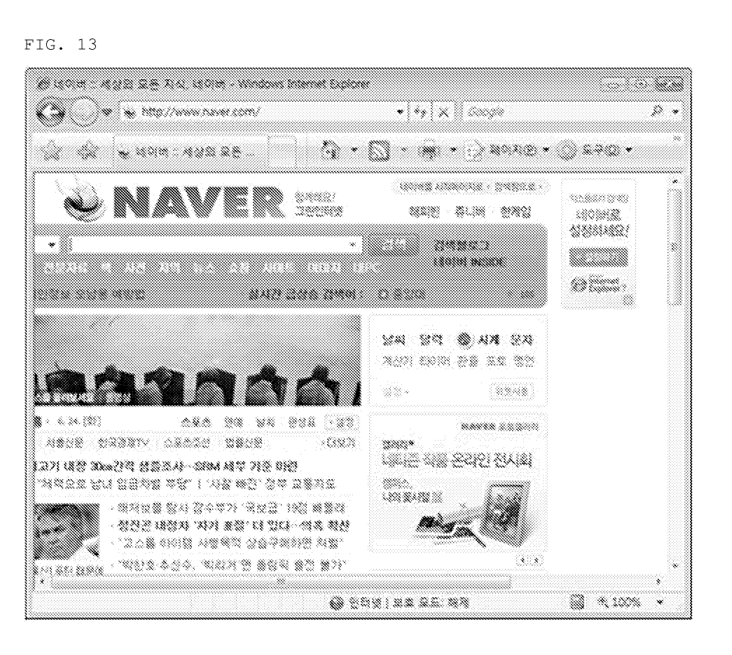

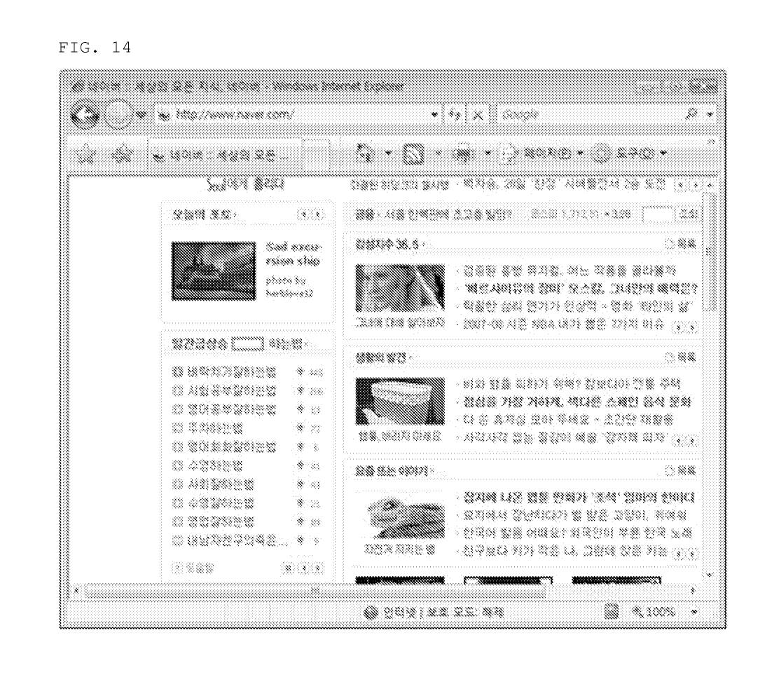

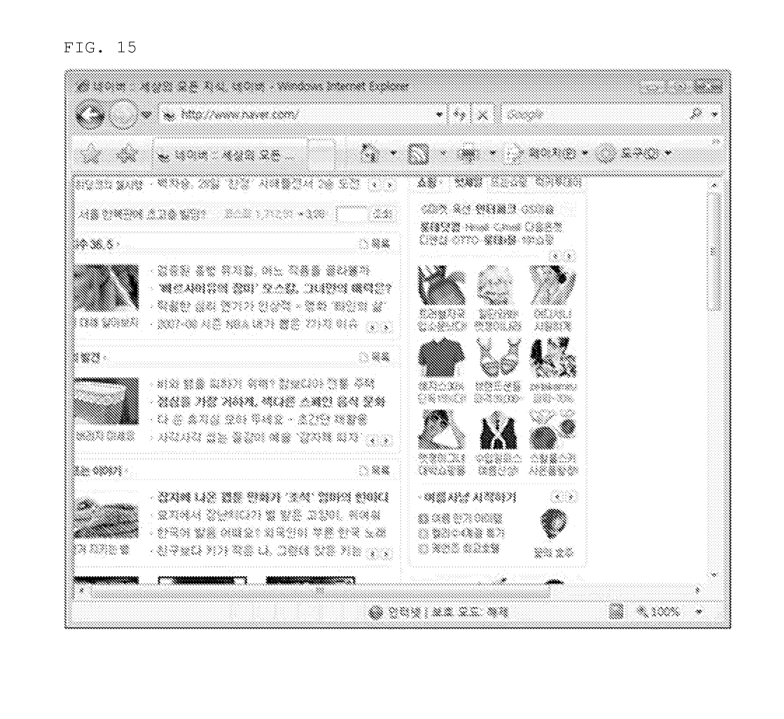

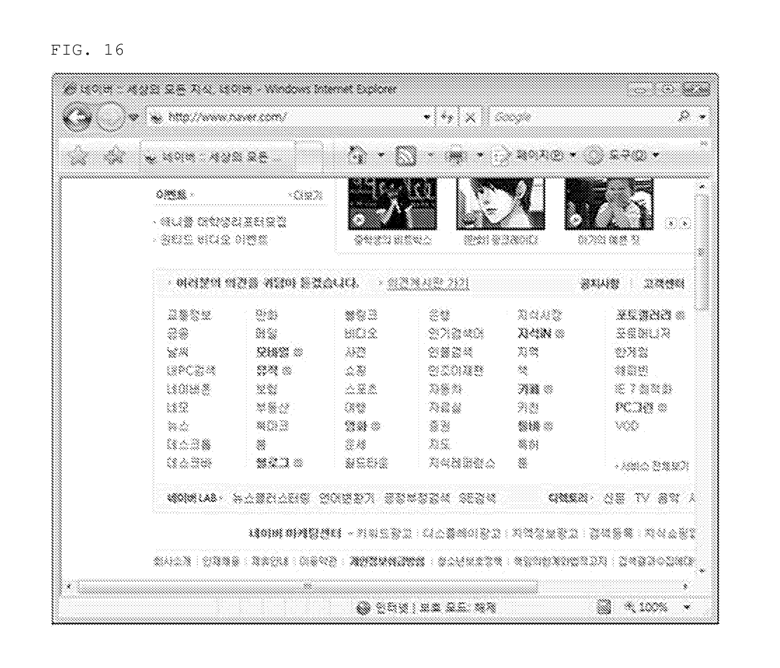

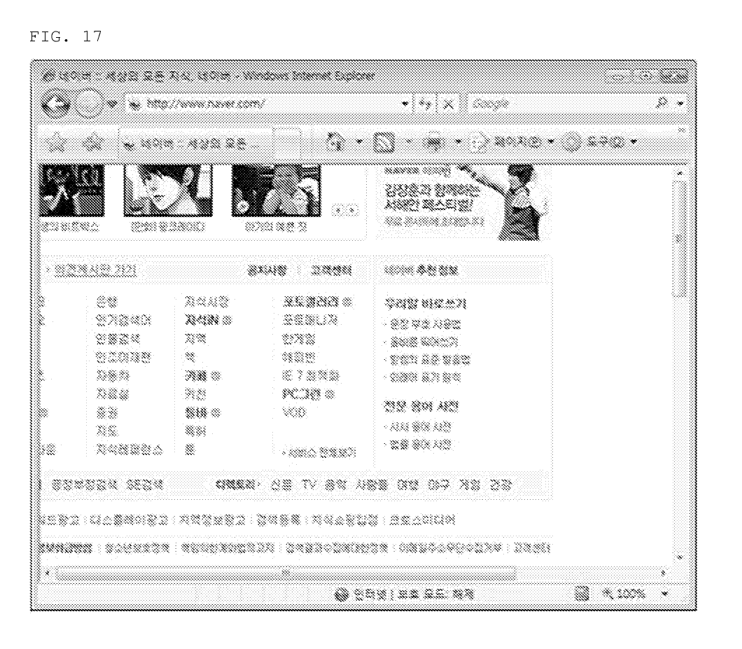

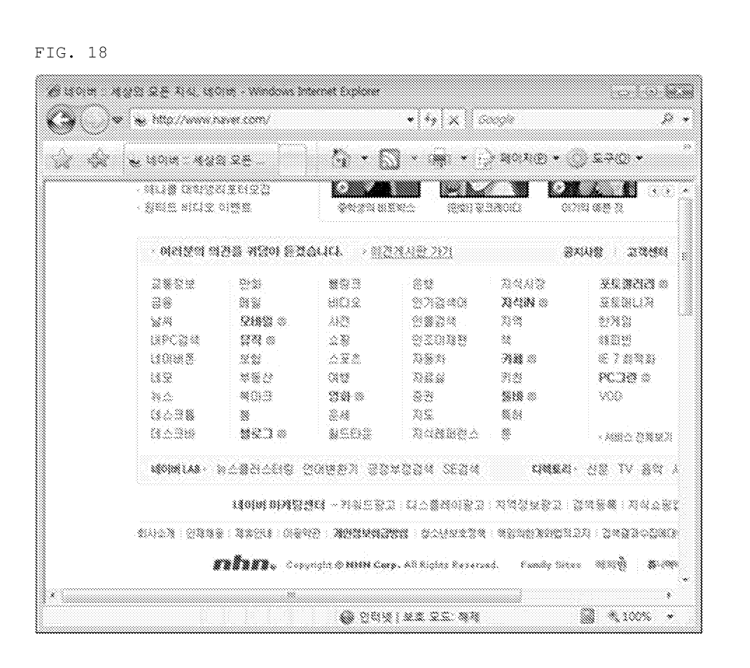

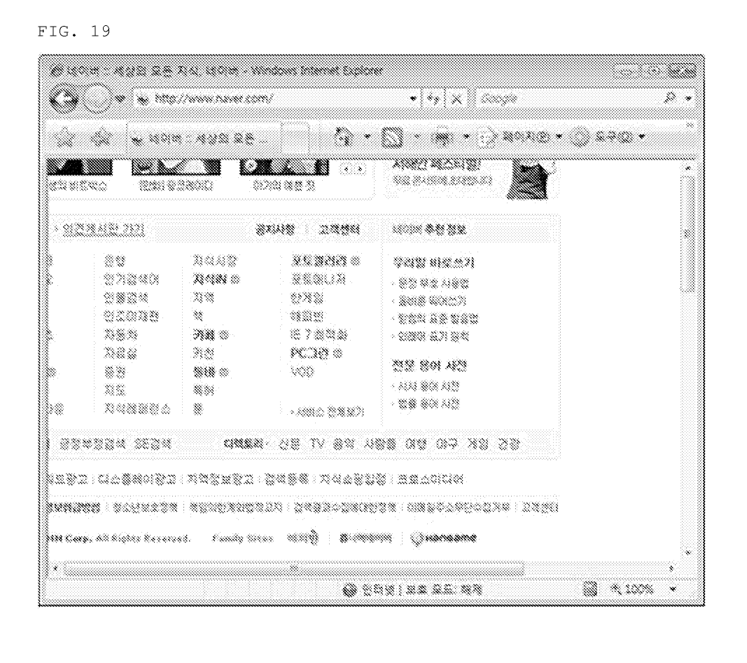

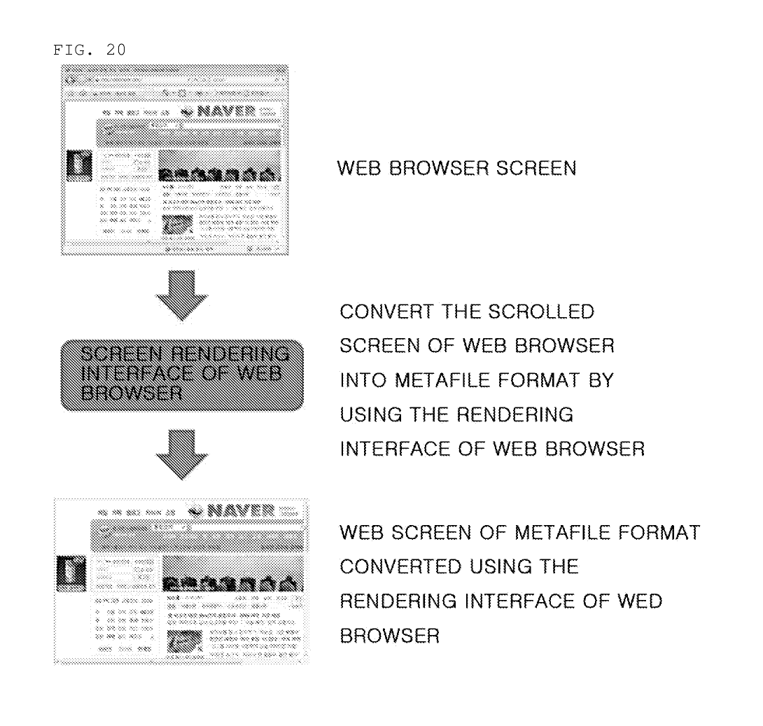

At this point, as illustrated in FIG. 2, when the web browser displays a partial region of the web page, the scroll capturing module 13 uses the DOM tree obtained from the web browser by the web browser control module 12 and the DOM node obtained from the DOM tree to move the initial scroll position of the web browser screen to the start point (0,0) of the web page as illustrated in FIG. 10, and automatically scrolls the web browser screen in the horizontal/vertical direction in the order of \textcircled{1}, \textcircled{2}, \textcircled{3}, \textcircled{4}, \textcircled{5}, \textcircled{6}, \textcircled{7}, \textcircled{8} from the start point of the web page as illustrated in FIG. 11 to capture the total region of the web page into 8 segments as illustrated in FIGS. 12 to 19.

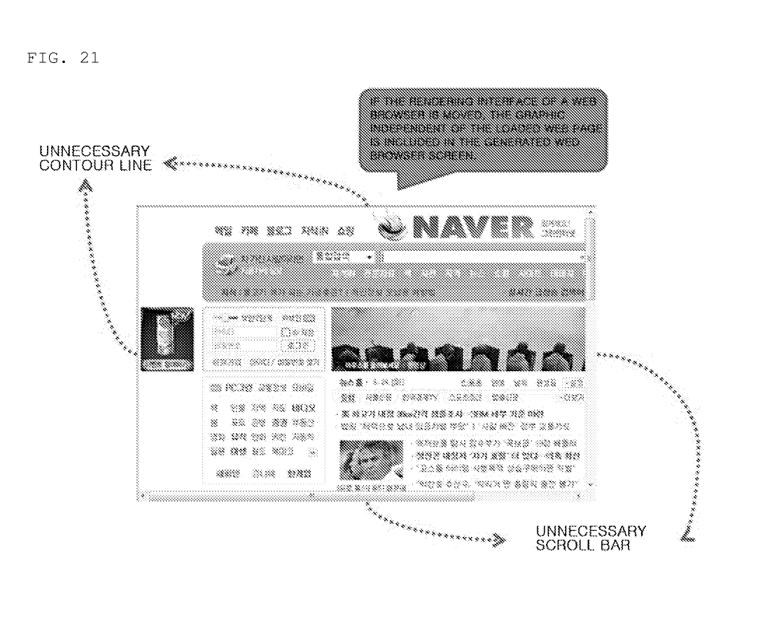

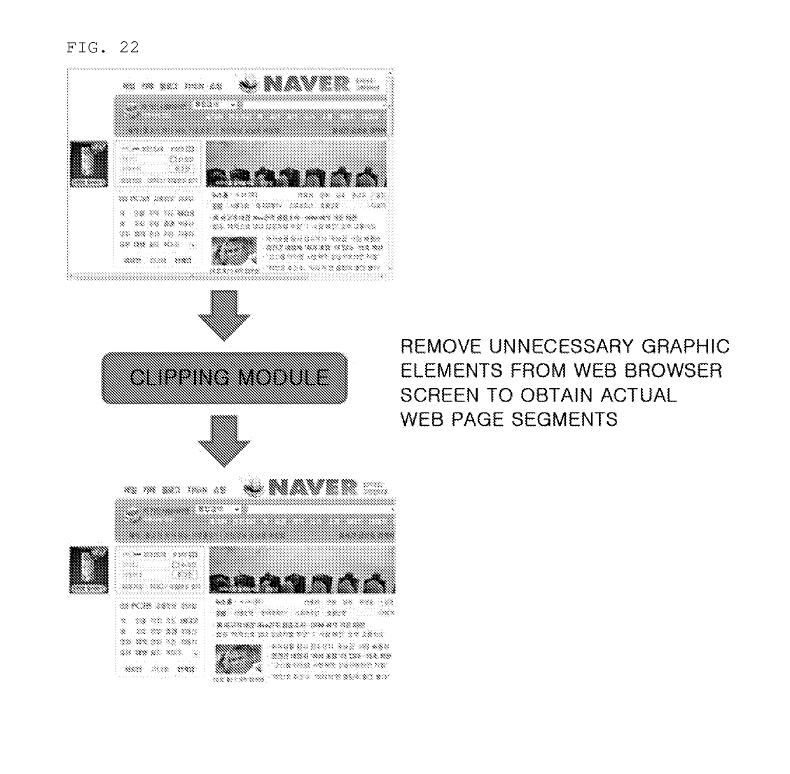

Also, as illustrated in FIG. 20, at each scroll, the web screen rendering interface of the web browser is used to divide the web browser screen on each scroll position into metafile segments as described above. Graphic elements irrelevant to the actual web page contents are included in the metafile segments. For example, unnecessary scroll bars and unnecessary contours irrelevant to the actual web page contents (i.e., pure web page contents) are included as illustrated in FIG. 21.

After the scroll capturing module 13 automatically scrolls the web browser screen in the horizontal/vertical direction to capture the total region of the web page into a plurality of segments, i.e., a plurality of metafile segments as described above (S14), the clipping module 14 removes unnecessary graphic elements from the captured web page screen segments (i.e., a plurality of metafile segments) to generate secondary metafiles including only pure web page contents (S16).

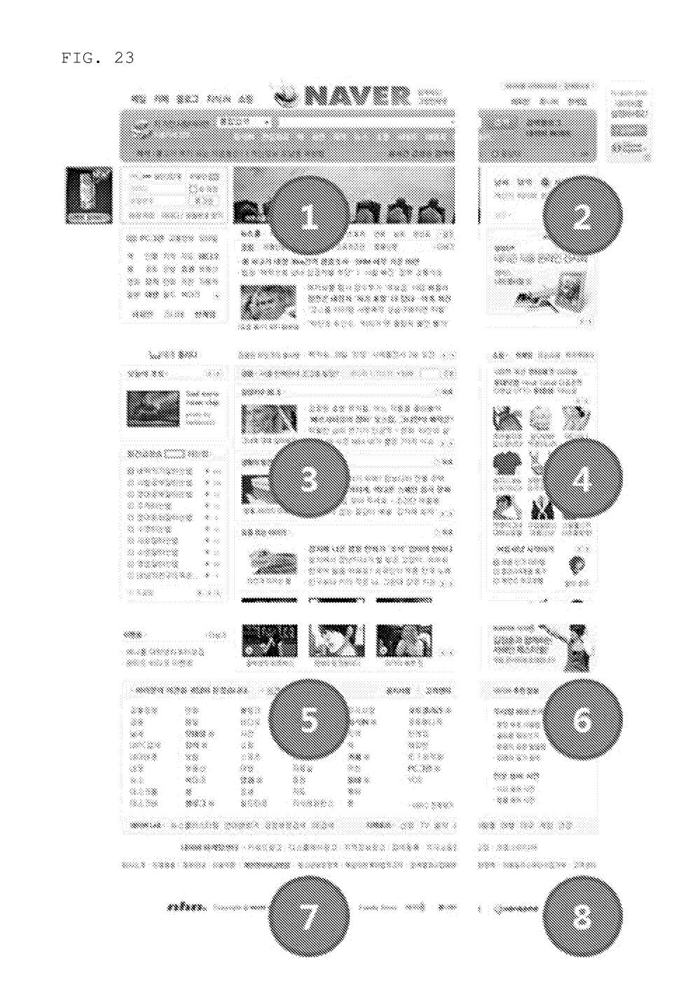

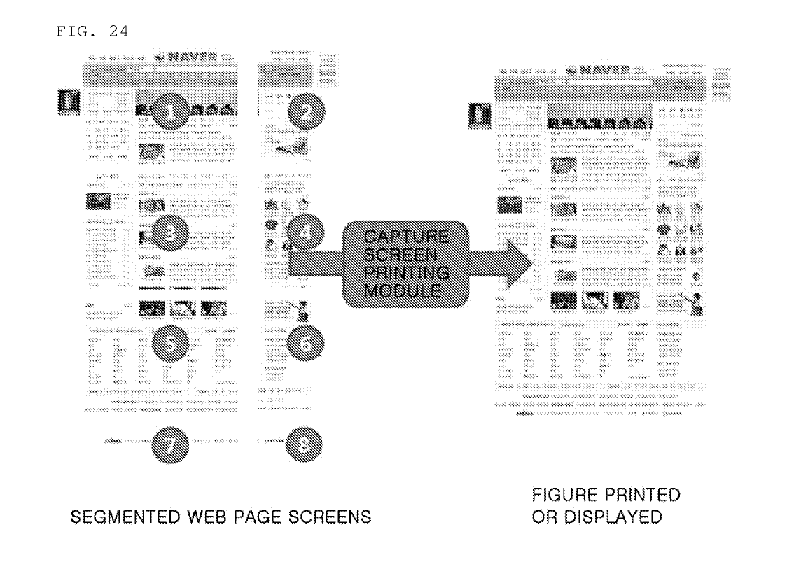

FIG. 22 illustrates a process of the clipping module 14 removing unnecessary scroll bars and unnecessary contours irrelevant to the pure web page contents from the metafile of FIG. 21 to generate a secondary metafile. FIG. 23 illustrates secondary metafiles corresponding to the captured screens of FIGS. 12 to 19 obtained through the above process.

The secondary metafile segments are stored in a data structure format together with a DOM tree obtained from the web browser by the web browser control module 12 and the coordinates on the actual web page obtained from a DOM node obtained from the DOM tree. Thereafter, the capture screen printing module 15 combines position information and the captured web page screen segments so that they can be stored and printed as one web page and it may be stored in a file format for later use.

After the secondary metafiles are generated by the clipping module 14 as described above, the capture screen printing module combines the secondary metafiles generated by the clipping module 14 to print or store the same as one web page screen as illustrated in FIG. 24 (S18).

At this point, a metafile such as the secondary metafile stores graphic elements such as lines, figures and letters included in the web page in a vector format. Therefore, if the secondary metafiles are simply combined prior to output, there occurs a gap between the secondary metafile segments in a printing or storing operation. In order to compensate this, the capture screen printing module 15 combines the secondary metafile segments in a partially layered manner, for example, by about 1˜3 pixels. In the case of FIG. 24, it is preferable that metafiles of \textcircled{1}, \textcircled{2}, \textcircled{3}, \textcircled{4}, \textcircled{5}, \textcircled{6}, \textcircled{7} and \textcircled{8} are combined by overlapping each other by 1˜3 pixels at a contact portion. For example, the metafile \textcircled{1} and the metafile \textcircled{2} are combined by overlapping each other by about 1˜3 pixels at a contact portion, that is, the right of the metafile \textcircled{1} and the left of the metafile \textcircled{2}. Also, the metafile \textcircled{1} and the metafile \textcircled{3} are combined by overlapping each other by about 1˜3 pixels at a contact portion, that is, the bottom of the metafile \textcircled{1} and the top of the metafile 3. The other metafiles are combined by overlapping each other in the same manner.

As described above, the present invention can overcome a problem that the quality of a printed material degrades when a captured screen of a web page displayed on a web browser screen is converted in a bitmap format prior to printing, a problem that a web page viewed by a web user through a web browser screen is not identically printed due to the restricted maximum size of a bitmap if the web page is long, and a problem that the web page contents exceeding the monitor screen of a web user are not printed if the total size of a web page is greater than the monitor resolution of the web user when a captured screen is converted into an Enhanced Meta File (EMF) prior to printing in order to improve the quality of a printed material.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for printing a captured screen of a web page, comprising:
a first process of loading, by a web user, a capture printing agent for a capture screen print service on a web browser through a web browser loading module included in the capture printing agent;
a second process of obtaining, by a web browser control module included in the capture printing agent, the total size of the web page and the size of a web page of the current web browser screen display region to calculate the necessary number of automatic horizontal/vertical scrolls of the web browser screen, in the event of a printing request of the web user in the state where the capture printing agent is loaded on the web browser;
a third process of automatically scrolling, by a scroll capturing module included in the capture printing agent, the web browser screen in the horizontal/vertical direction according to the necessary number of the scrolls calculated by the web browser control module and using a metafile Device Context (DC) among the Graphic Device Interface (GDI) subsystem functions of a Windows operating system to capture the total region of the web page into a plurality of metafile segments;
a fourth process of removing, by a clipping module included in the capture printing agent, unnecessary graphic elements from the captured metafile segments to generate secondary metafiles including only pure web page contents; and
a fifth process of combining, by a capture screen printing module included in the capture printing agent, the secondary metafiles generated by the clipping module to print or store the same as one web page screen.

2. The method of claim 2, wherein, in the second process, the web browser control module obtains a Document Object Model (DOM) tree, which the web browser interprets an HTML file type web page to generate, obtains a DOM node (HTML tag or BODY on HTML) representing the web page among the nodes of the DOM tree, obtains the total size of the node and the size of a region displayed on the web browser screen on a pixel basis, and obtains the actual total size of the web page and the size of a region among the web page contents displayed in the web browser, to calculate the necessary number of automatic horizontal/vertical scrolls of the web browser screen.

3. The method of claim 1, wherein, in the fifth process, the capture screen printing module combines the captured web page screen segments including only pure web page contents, that is, the secondary metafile segments, in a partially layered manner.

4. The method of claim 3, wherein, in the fifth process, the capture screen printing module combines the secondary metafile segments by overlapping each other by about 1˜3 pixels.
